(19) United States
(12) Patent Application Publication
(10) Pub. No.: US 2012/0085792 A1
(43) Pub. Date: Apr. 12, 2012

(54) FLUID NOZZLE SYSTEM

(76) Inventor: D. Michael Carriere, Negaunee, MI (US)

(21) Appl. No.: 13/267,596

(22) Filed: Oct. 6, 2011

Related U.S. Application Data
(60) Provisional application No. 61/390,484, filed on Oct. 6, 2010.

(51) Int. Cl. B67D 3/00

(52) U.S. Cl. 222/527

(57) ABSTRACT

The present disclosure includes fluid nozzle devices and systems. One fluid nozzle system embodiment includes a body having a series of sections that can be individually changed between an expandable and collapsible state to allow the body to lengthened, shortened, or curved and a fluid flow lumen formed in the body from a first end to a second end; the first end having an opening into the lumen and having a portion configured to receive a cap thereon; and a size adapter attached to the collar, the size adapter being configured to attach to a portion of a body of a fluid storage container having an opening for pouring a fluid out of the container.

### RELATED APPLICATION

This patent application is related to, and claims priority to, U.S. Provisional Patent Application Ser. No. 61/390,484, entitled “Fluid Nozzle System,” Attorney Docket No. 240.001999P, filed on Oct. 6, 2010, hereby incorporated by reference in its entirety.

### TECHNICAL FIELD

The present disclosure relates generally to sealable fluid containers, and more particularly, to a fluid nozzle system.

### BACKGROUND

Storage containers for fluids have been part of our daily lives for many decades. As used herein, the term “fluid storage container” applies to containers used to store fluids which are commonly found and dispensed in the home, garage, in recreational type vehicles, and used in the community at large. For purposes of the present disclosure the term “fluid”, as used herein, connotes liquids, powders, and any other type of material that can be poured out of a container and wherein an embodiment of the present disclosure would be of benefit, such as water, oil, antifreeze, windshield washer fluid, household fluids, etc.

Such fluid storage containers, for example, can carry a supply of oil for a vehicle. Originally, such cans were made of metal, however, over time, the containers came to be made of plastic and adopted a smaller size and shape. Typical oil containers come in a 1 quart size and have the same shape and thread style at the opening in the container through which the fluid is poured, discussed herein as a fluid port.

Some, fluid storage containers have a fluid port and a vent. The fluid port is often larger than the vent and may be used for filling the fluid storage container and/or draining fluid out of the fluid storage container.

The vent allows air to be displaced as fluid flows into or out of the fluid storage container. In some implementations, one or both the port and vent are sealable to contain the fluid and, in some arrangements, its vapors within the fluid storage container. Some containers use a fluid port with no vent.

The port of some typical fluid storage containers are fitted with a nozzle, the nozzle having a base end and a spout (e.g., opening) with a fluid channel there-between. The nozzle may be permanently attached or detachable. The nozzle acts like a funnel, channeling fluid from the container such that it can be directed more accurately, for example into the port of another fluid receptacle. In some arrangements, a detachable nozzle is secured onto the port using a screw-on collar that may be integral to, or separate from, the nozzle itself. The screw-on collar exerts force to push the nozzle in fluid communication with the port.

In some arrangements, the detachable nozzle can be removed and stored “upside-down” inside the container when it is not in use. For example, an integral collar can have screw threads on both ends such that the nozzle can be attached to the port in two directions, extending from the fluid storage container, or extending into the fluid storage container. In another previous approach the nozzle and collar are separated, the nozzle is inverted into the container, and the collar secures the inverted nozzle into fluid communication, albeit upside-down, with the port.

Typically, a thin membrane such as a round sealing disk is inserted between an inverted detachable nozzle stowed in the container and the screw-on collar to seal the port. The screw-on collar exerts force to push the sealing disk towards the base of the nozzle thereby sealing the fluid pathway of the nozzle, and the port to prevent leaks. According to yet another previous approach, the nozzle is left in place and sealed by a screw-on or snap-on spout cap fitted over the spout opening.

To fill a fluid storage container with a detachable nozzle stored within the container, a user first removes the screw-on cap, or collar, disk, and nozzle. The vent is opened, and the container is filled with fluid through the open port, and sealed-up as previously described. To pour a fluid from a sealed container, the user removes the screw on cap/cover, removes the nozzle, reverses it, places the nozzle on the port, replaces the screw-on collar, opens the vent, and pours the fluid.

Although the above-mentioned container configurations worked, they have a number of problems. First, by storing the nozzle in the container, the user is exposed to the fluid in the can when removing and reversing the nozzle.

In some implementations, the user can come in contact with the fluid during the nozzle re-configuration process, which can be messy. Also, the sealing disk can be misplaced or lost, and the re-configuration process takes time.

### BRIEF DESCRIPTION OF THE DRAWINGS

FIG. 1 illustrates a side view of a fluid nozzle system in accordance with one or more embodiments of the present disclosure.

FIG. 2 illustrates an exploded side perspective view of a fluid nozzle system in accordance with one or more embodiments of the present disclosure.

FIG. 3 illustrates a side perspective view of an example of a type of size adaptor that may be used in one or more embodiments of the present disclosure.

FIG. 4 illustrates a side perspective view of an example of a type of collar that may be used in one or more embodiments of the present disclosure.

FIG. 5 illustrates a cut away side view of the example size adaptor.

### DETAILED DESCRIPTION

The present disclosure includes devices and systems for a fluid nozzle. One fluid nozzle system embodiment includes a body having a series of sections that can be individually changed between an expandable and collapsible state to allow the body to lengthened, shortened, or curved and a fluid flow lumen formed in the body from a first end to a second end; the first end having an opening into the lumen and having a portion configured to receive a cap thereon; and a size adapter attached to the collar, the size adapter being configured to attach to a portion of a body of a fluid storage container having an opening for pouring a fluid out of the container.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process and/or structural changes may be made without departing from the scope of the present disclosure.

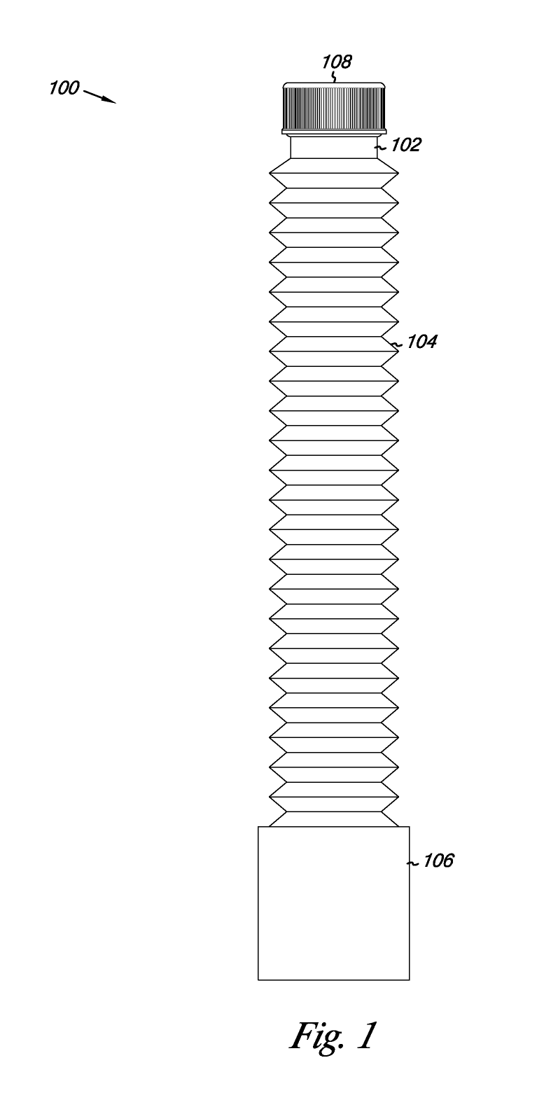

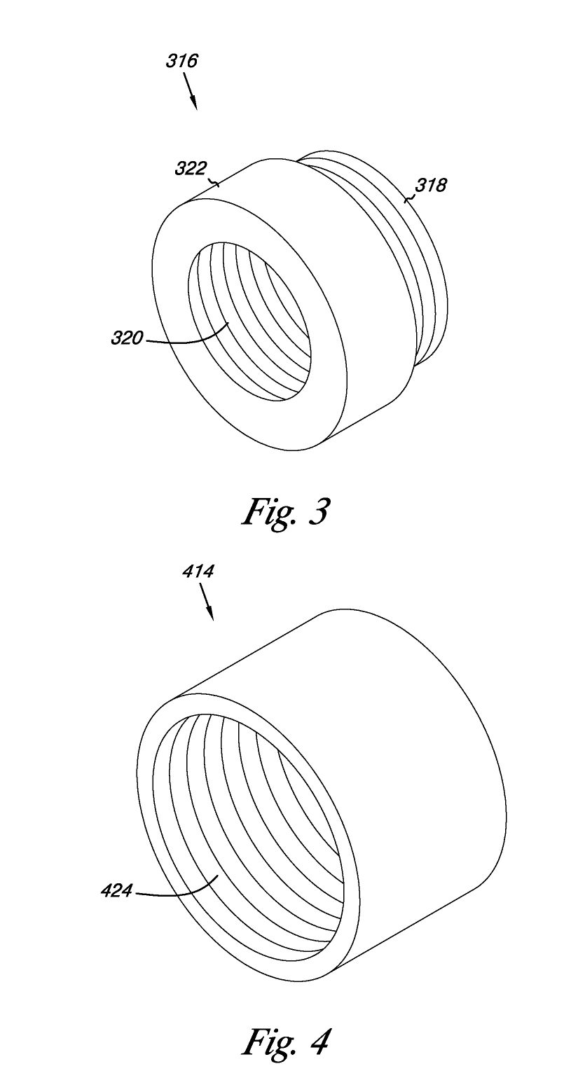

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1A, and a similar element may be referenced as 310 in FIG. 3A.

As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present invention, and should not be taken in a limiting sense.

FIG. 1 illustrates a side view of a fluid nozzle system in accordance with one or more embodiments of the present disclosure. In the embodiment of FIG. 1, the fluid nozzle system 100 generally includes a body 104 that forms a lumen for the passage of fluids into one end of the nozzle body 104 and out of the other end of the nozzle body 104.

The body has a first end 102 that includes a portion thereon to receive the cap 108 for securement thereto. In some embodiments, the cap 108 can be a fluid tight cap which can be beneficial, for example, to prevent the escape of fluid therefrom. This will eliminate leakage of fluid onto items upon which the fluid nozzle is set when in use or not in use on a container and can reduce the passage of fluid onto a user.

The cap can be any suitable type of cap and can, for example, thread internally into or externally around the first end 102. In some embodiments, the cap 108 can be a frictional fit on or in the first end 102.

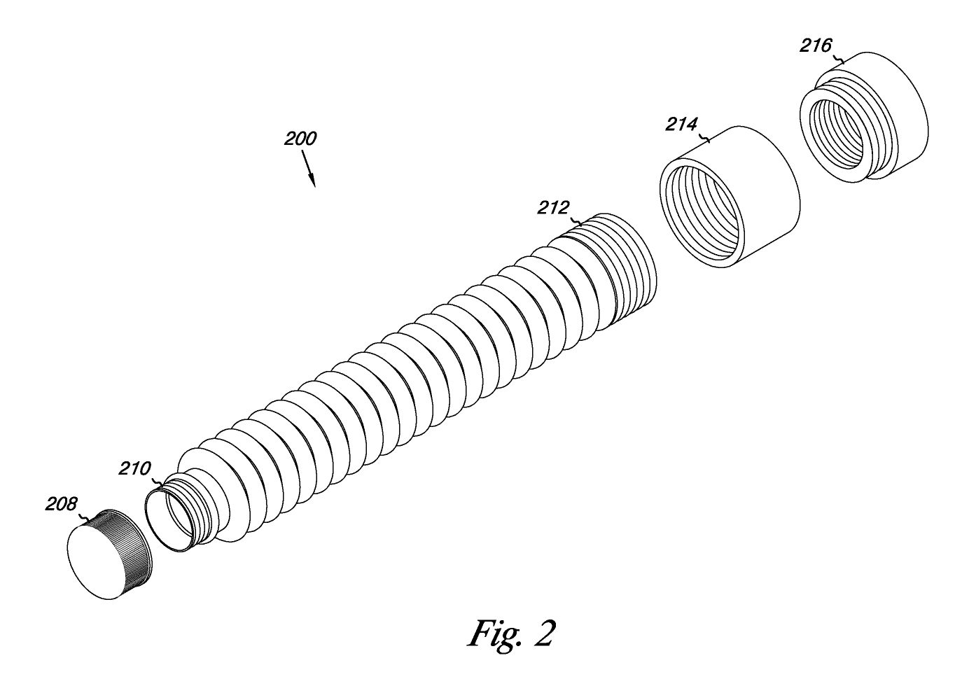

In some embodiments, an adapter can be screwed onto the pouring end of the spout that would accommodate pours that require a narrower application, such as transmission fluids and/or water poured into clothes iron. The first end 102 may receive the narrowing adapter in a manner similar to which the first end 102 receives the cap 108 (e.g., via external threads as shown in FIG. 2), and/or first end 102 may receive the narrowing adapter via internal threading of first end 102, or via other coupling mechanism internal or external to first end 102.

In some embodiments, the body has a series of sections that can be individually changed between an expandable and collapsible state to allow the body to be lengthened, shortened, or curved. In the embodiment illustrated in FIG. 1, the series of sections are accordion style; however, other suitable structures can be utilized.

This can be beneficial because it allows the system to be applied in more situations where such features would allow for the system's use. This also allows for the system 100 to be stored in a collapsed state thereby reducing the space needed for storage of the system 100 and may make the system 100 more readily portable.

The body 104 can be made for any suitable material or combination of materials. One suitable type of material is tetrafluoroethylene. The use of tetrafluoroethylene materials such as polytetrafluoroethylene (PTFE) can be beneficial as it has a low co-efficient of friction and therefore fluids do not readily adhere to its surface. The entire body 104 can be fabricated from tetrafluoroethylene type materials or tetrafluoroethylene materials can form a portion of the body 104 or be combined with other materials to form the body 104.

The second end of body 104 includes a collar 106 thereon. The collar 106 can be used for attachment of the second end of the body 104 to a container. The system 100 can then be used to pour fluids out of the container through the fluid nozzle system 100 and out first end 102, when the cap 108 is removed.

In such embodiments, the collar 106 can be designed to frictionally fasten (e.g., male-female connection) or mechanically fasten (e.g., mating threaded connection) to the container. For example, in some embodiments, the collar 106 is fixed to the second end of the body 104.

In various embodiments, the collar can be configured to attach to a portion of a body of a fluid storage container having an opening for pouring a fluid out of the container. This can be a permanent or releasable attachment to the container. Releasable configurations allow for the system 100 to be removed and reattached at a later time and can allow for the system 100 to be used on different containers (e.g., oil bottles, etc.) as will be described in further detail below.

FIG. 2 illustrates an exploded side perspective view of a fluid nozzle system in accordance with one or more embodiments of the present disclosure. The embodiment of FIG. 2 is similar to that of FIG. 1, but with some differences as will be discussed below.

In the embodiment of FIG. 2, the system 200 includes a body having a first end 210 and a second end 212. In this embodiment, the first end includes an opening into the lumen and has a portion configured to receive a cap 208 thereon.

The first end 210 includes external threading to attach the cap 208 to the first end 210. Likewise, the cap includes internal threads that mate with the external threads on the surface of the portion of the first end that has been configured to receive the cap. As discussed above, other mechanisms can be used to provide such attachment.

The embodiment of FIG. 2 also includes a collar 214 that is configured to be fixed to the second end 212 of the body. In the illustrated embodiment of FIG. 2, a portion (e.g., a first end of the collar) is configured to be threaded onto the second end 212. In some frictionally or threaded embodiments, the collar can be affixed using an adhesive positioned between the surface of the second end 212 and the collar 214.

As discussed with regard to the embodiment of FIG. 1, some embodiments may include a collar having a portion (e.g., a second end) configured to attach to a container. In the embodiment of FIG. 2, the second end of the collar 214 is configured to attach to a size adaptor 216 instead of, or in addition to, being configured for attachment to a container.

In the embodiment illustrated in FIG. 2, the size adaptor 216 includes threads for its attachment to the collar 214. In such embodiments, the size adapter is configured to attach to a portion of a body of a fluid storage container having an opening for pouring a fluid out of the container.

Although threaded and frictional attachment mechanisms are discussed in some detail herein, any suitable permanent or releasable attachment mechanism can be used for attachment thereto. For example, in some threaded or frictionally attached embodiments, the collar is releasably fixed to the second end such that the collar can be removed and re-attached or another collar can be attached to the second end.

Further, in some embodiments, the collar 214 forms a fluid tight connection with the second end 212 to prevent the escape of fluid therefrom. In various embodiments, as discussed above, the collar 214 forms a frictional fitting connection with the second end 212 to hold the collar and second end together.

In embodiments that are releasably attached, the size adapter can be releasably fixed to the collar such that the size adapter can be removed and re-attached or another size adapter can be attached to the collar. Further, in some embodiments, the size adapter 216 is configured to form a fluid tight connection with the portion of a body of a fluid storage container having an opening for pouring a fluid out of the container. In some such embodiments, the size adapter is configured to form a frictional fitting connection with the portion of a body of a fluid storage container having an opening for pouring a fluid out of the container.

FIG. 3 illustrates a side perspective view of an example of a type of size adaptor that may be used in one or more embodiments of the present disclosure. In the embodiment of FIG. 3, the size adaptor 316 has a first diameter for attachment to a collar, such as collar 214 of FIG. 2.

The size adaptor has a second diameter of attachment to a container. In some embodiments, the diameter for attachment to the collar may be larger than that for attachment to the container and in other embodiments, the reverse may be the case, where the diameter for attachment to the collar may be smaller than that for attachment to the container. In some embodiments, the diameter for attachment to the collar may be the same as that for attachment to the container.

In some embodiments, the system may include multiple size adaptors to allow the fluid nozzle system to be used for multiple containers. In some such embodiments, the multiple size adaptors may include different diameter combinations of the same type of size adaptor (e.g., multiple size adaptors each having the diameter for attachment to the collar that is smaller than that for attachment to the container) or may be combinations of two or more of the types described above (e.g., one having the diameter for attachment to the collar that is larger than that for attachment to the container and another having the diameter for attachment to the collar that is smaller than that for attachment to the container).

Additionally, in some embodiments, one or more of the surfaces 318, 320, and/or 322 can have a mating surface thereon for mating engagement with either a surface on the collar and/or on the container. A threaded surface is one type of suitable mating surface.

FIG. 4 illustrates a side perspective view of an example of a type of collar that may be used in one or more embodiments of the present disclosure. As discussed above, a collar 414, such as that illustrated in FIG. 4, can be used as a mechanism for attachment of the second end of the fluid nozzle body to a container, as illustrated in FIG. 1. It can also be used between the fluid nozzle body and a size adaptor, as illustrated in FIG. 2.

In the embodiment shown in FIG. 4, the collar is a friction fit or adhesive attached type of collar for both attachment to the second end of the body and to the size adaptor or container. However, one or more portions of the interior surface 424 or exterior surface of the collar 414 can have mating surfaces there on to releasably or permanently mechanically attach the collar.

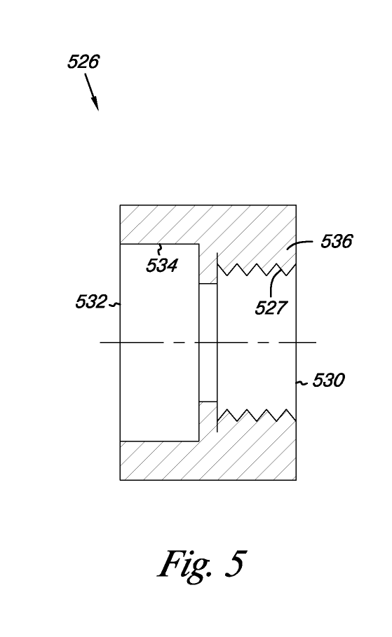

FIG. 5 illustrates a cut away side view of the example size adaptor illustrated. Illustrated in FIG. 5 are some different diameter configurations of the two portions of the size adaptor. For example, the size adaptor body 536 includes a first end 532 for connection to a container wherein the first end 532 includes a first opening 534 having a first diameter.

The size adaptor body 536 also includes a second end 532 for connection to a collar or the nozzle body wherein the second end 530 includes a second opening 527 having a second diameter. The embodiment of FIG. 5 also includes a set of internal threads in opening 527 to aid in attachment of the size adaptor to a collar or to the second end of the nozzle body.

In some embodiments, the diameter and spacing of the threads shown and described herein can be configured so as to correspond to the threading specifications of gas cans, including those gas cans manufactured without recently-mandated spill-related safety features.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. As used herein, the term “and/or” includes any and all combinations of one or more of the associated listed items.

It will be understood that, although the terms first, second, etc. may be used herein to describe various elements and that these elements should not be limited by these terms. These terms are only used to distinguish one element from another element. Thus, a first element could be termed a second element without departing from the teachings of the present disclosure.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A fluid nozzle system, comprising:
a body having a series of sections that can be individually changed between an expandable and collapsible state to allow the body to lengthened, shortened, or curved and a fluid flow lumen formed in the body from a first end to a second end;
the first end having an opening into the lumen and having a portion configured to receive a cap thereon;
a collar fixed to the second end of the body; and
a size adapter attached to the collar, the size adapter being configured to attach to a portion of a body of a fluid storage container having an opening for pouring a fluid out of the container.

2. The fluid nozzle system of claim 1, wherein the fluid tight cap includes internal threads that mate with the surface of the portion of the first end configured to receive the cap.

3. The fluid nozzle system of claim 1, wherein the collar is releasably fixed to the second end such that the collar can be removed and re-attached or another collar can be attached to the second end.

4. The fluid nozzle system of claim 1, wherein the size adapter is releasably fixed to the collar such that the size adapter can be removed and re-attached or another size adapter can be attached to the collar.

5. The fluid nozzle system of claim 1, wherein the collar forms a fluid tight connection with the second end to prevent the escape of fluid therefrom.

6. The fluid nozzle system of claim 1, wherein the collar forms a frictional fitting connection with the second end to hold the collar and second end together.

7. The fluid nozzle system of claim 1, wherein the size adapter is configured to form a fluid tight connection with the portion of a body of a fluid storage container having an opening for pouring a fluid out of the container.

8. The fluid nozzle system of claim 1, wherein the size adapter is configured to form a frictional fitting connection with the portion of a body of a fluid storage container having an opening for pouring a fluid out of the container.

9. The fluid nozzle system of claim 1, wherein the body is formed from a tetrafluoroethylene material.

10. A fluid nozzle system, comprising:
a body having a series of sections that can be individually changed between an expandable and collapsible state to allow the body to lengthened, shortened, or curved and a fluid flow lumen formed in the body from a first end to a second end;
the first end having an opening into the lumen and having a portion configured to removably receive a first cap thereon; and
a collar fixed to the second end of the body being configured to attach to a portion of a body of a fluid storage container having an opening for pouring a fluid out of the container.

11. A fluid nozzle system, comprising:
a body having a series of sections that can be individually changed between an expandable and collapsible state to allow the body to lengthened, shortened, or curved and a fluid flow lumen formed in the body from a first end to a second end;
the first end having an opening into the lumen and having a portion configured to removably receive a first cap thereon;
a collar fixed to the second end of the body; and
a size adapter attached to the collar, the size adapter being configured to attach to a portion of a body of a fluid storage container having an opening for pouring a fluid out of the container.
